(19) United States
(12) Patent Application Publication
(10) Pub. No.: US 2010/0309136 A1
(43) Pub. Date: Dec. 9, 2010

(54) Wireless Operating Device and Electronic Apparatus having the same

(75) Inventors: Su-Cheng Liu, Hsinchu (TW); Yi-Ching Wang, Hsinchu (TW); Ted-Hong Shinn, Hsinchu (TW)

Correspondence Address: LanWay IPR Services, P.O. Box 220746, Chantilly, VA, 20153, US

(73) Assignee: Prime View International Co., Ltd.

(21) Appl. No.: 12/632,800

(22) Filed: Dec. 8, 2009

(30) Foreign Application Priority Data
Jun. 5, 2009 (TW) 098118824

(51) Int. Cl. G06F 3/02; G06F 3/041; H04B 7/00

(52) U.S. Cl. 345/169; 345/173; 455/41.2

(57) ABSTRACT

A wireless operating device includes a display panel, a touch panel and a control module. The display panel has a display area. The touch panel corresponds to the display area. The control module includes a substrate, a processing unit and a wireless transmission unit. The substrate is electrically connected to the display panel and the touch panel. The processing unit and the wireless transmission unit are disposed on and electrically connected to the substrate. The processing unit is configured for controlling the display panel to display an operating image in the display area, and controlling the wireless transmission unit to send an operating signal according to an operation applied on the operating image. The wireless operating device utilizes the display area to display various operating images to control various electronic devices, thereby improving the compatibility of the wireless operating device.

### CROSS-REFERENCE TO RELATED APPLICATIONS

This application is based upon and claims the benefit of priority from the prior Taiwanese Patent Application No. 098118824, filed Jun. 5, 2009, the entire contents of which are incorporated herein by reference.

### BACKGROUND

1. Field of the Invention

The present invention relates to a wireless operating device, and particularly to a wireless operating device configured for operating various electronic devices and an electronic apparatus having the wireless operating device.

2. Description of the Related Art

In recent years, various electronic devices become more and more popular. Almost every family is equipped with a few electronic devices such as televisions, air conditioners, and multimedia players, and so on. Each of these electronic devices has a respective typical operating device, for example, a remote control. However, the typical operating devices for these electronic devices have poor compatibility. For example, the remote control for operating the television can not be used to operate the air conditioner. Thus, the various electronic devices can not be operated until the operating devices corresponding to the various electronic devices are used. When the electronic devices are left unused, the operating devices corresponding to the various electronic devices must be kept appropriately so as to avoid losing the operating devices. So many operating devices will need a big space to be received and kept. Furthermore, manufacture of so many operating devices wastes resources.

Therefore, what is needed is an operating device with high compatibility that is capable of operating various electronic devices.

### BRIEF SUMMARY

The present invention provides a wireless operating device configured for operating various electronic devices.

The present invention also provides an electronic apparatus having a wireless operating device. The wireless operating device is capable of operating various electronic devices of the electronic apparatus.

The present invention provides a wireless operating device. The wireless operating device includes a display panel, a touch panel and a control module. The display panel has a display area. The touch panel corresponds to the display area of the display panel. The control module includes a substrate, a processing unit and a wireless transmission unit. The substrate is electrically connected to the display panel and the touch panel. The processing unit and the wireless transmission unit are disposed on and electrically connected to the substrate. The processing unit is configured for controlling the display panel to display an operating image in the display area, and controlling the wireless transmission unit to send an operating signal according to an operation applied on the operating image.

The present invention provides an electronic apparatus. The electronic apparatus includes an aforementioned wireless operating device and at least an electronic device. The at least an electronic device includes a wireless receiving module for receiving the operating signal sent from the wireless transmission unit.

In one embodiment provided by the present invention, the operating image includes at least a function switch key for switching various operating images.

In one embodiment provided by the present invention, the wireless operating device includes at least a function switch key disposed at a side of the display area of the display panel and electrically connected to the control module. The function switch key is configured for switching various operating images.

In one embodiment provided by the present invention, the operating image is selected from a group consisting of a keyboard image and a remote control image with a number of control keys.

In one embodiment provided by the present invention, the display panel is a flexible display panel.

In one embodiment provided by the present invention, the display panel is an electronic paper display panel.

In one embodiment provided by the present invention, the display panel is selected from a group consisting of an electrophoretic display panel, a cholesteric liquid crystal display panel, and an electrowetting display panel.

In one embodiment provided by the present invention, the display panel is a monochrome display panel or a color display panel.

In one embodiment provided by the present invention, the touch panel is selected from a group consisting of a resistive touch panel, a capacitive touch panel, an optical touch panel, and a piezoelectric touch panel.

In one embodiment provided by the present invention, the operating signal sent from the wireless transmission unit conforms to a standard selected from a group consisting of infrared standard, bluetooth standard, radio frequency identification standard, IEEE 802.11a standard, IEEE 802.11b standard and IEEE 802.11g standard.

The wireless operating device of the present invention utilizes the display area to display various operating images according to various electronic devices to control various electronic devices. Thus, the wireless operating device of the present invention can operate various electronic devices, thereby improving the compatibility of the wireless operating device. Additionally, the electronic apparatus of the present invention can use a wireless operating device to operate each of the electronic devices of the electronic apparatus, thereby decreasing the number of the wireless operating devices.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of an electronic apparatus in accordance with an embodiment of the present invention.

FIG. 2 is a schematic view of a wireless operating device of the electronic apparatus shown in FIG. 1.

FIG. 3 is a schematic view of a display panel of the wireless operating device shown in FIG. 2.

FIG. 4A is a schematic view of an operating image of the display panel of the wireless operating device, which is a keyboard image for operating an electronic device.

FIG. 4B is a schematic view of an operating image of the display panel of the wireless operating device, which is another keyboard image for operating an electronic device.

FIG. 4C is a schematic view of an operating image of the display panel of the wireless operating device, which is a remote control image for operating an electronic device.

FIG. 5 is a schematic view of a display panel of a wireless operating device in accordance with another embodiment of the present invention.

### DETAILED DESCRIPTION

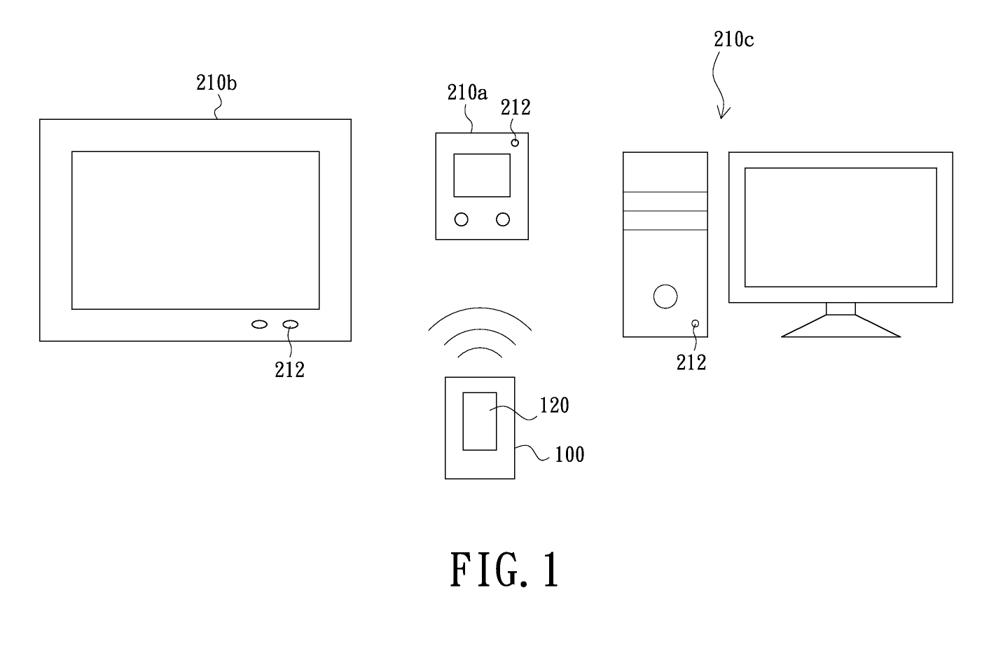

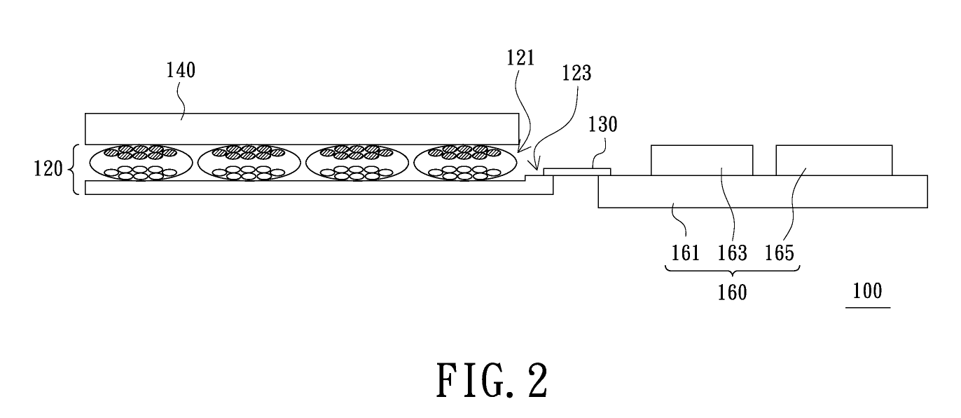

FIG. 1 is a schematic view of an electronic apparatus in accordance with an embodiment of the present invention. FIG. 2 is a schematic view of a wireless operating device of the electronic apparatus shown in FIG. 1. Referring to FIGS. 1 and 2, in the present embodiment, the electronic apparatus includes a wireless operating device 100 and at least an electronic device. In FIG. 1, for example, the electronic apparatus includes three electronic devices 210a, 210b and 210c. The wireless operating device 100 is configured for operating the three electronic devices 210a, 210b and 210c.

The wireless operating device 100 includes a display panel 120, a touch panel 140 and a control module 160. The display panel 120 has a display area 121. The touch panel 140 corresponds to the display area 121 of the display panel 120. The control module 160 includes a substrate 161, a processing unit 163 and a wireless transmission unit 165. The substrate 161 is electrically connected to the display panel 120 and the touch panel 140. The processing unit 163 and the wireless transmission unit 165 are disposed on and electrically connected to the substrate 161. The processing unit 163 is configured for controlling the display panel 120 to display an operating image in the display area 121, and for controlling the wireless transmission unit 165 to send an operating signal according to an operation applied on the operating image by an user. Each of the three electronic devices 210a, 210b and 210c has a wireless receiving module 212. The wireless receiving module 212 is configured for receiving the operating signal sent from the wireless transmission unit 165 so as to let the electronic device 210a, 210b or 210c execute corresponding operation according to the operating signal.

In the present embodiment, the touch panel 140 is located above the display area 121 of the display panel 120. It noted that the touch panel 140 can be located under the display area 121 of the display panel 120. In addition, the substrate 161 is, for example, a printed circuit board. The substrate 161 is electrically connected to the display panel 120 and the touch panel 140 via a flexible substrate 130 (e.g., a flexible printed circuit board).

The display panel 120 can be a flexible display panel or a rigid display panel. In addition, the display panel 120 can be an electronic paper display panel such as an electrophoretic display panel, a cholesteric liquid crystal display panel or an electrowetting display panel. The electrophoretic display panel can be a microencapsulated electrophoretic display panel or a microcup electrophoretic display panel. In the present embodiment, FIG. 2 shows the microencapsulated electrophoretic display panel. Further, the display panel 120 can be a monochrome display panel or a color display panel.

The touch panel 140 can be selected from, but not limited to, a group consisting of a resistive touch panel, a capacitive touch panel, an optical touch panel, and a piezoelectric touch panel. Additionally, the operating signal sent from the wireless transmission unit 165 conforms to a standard selected from a group consisting of infrared standard, bluetooth standard, radio frequency identification standard, IEEE 802.11a standard, IEEE 802.11b standard and IEEE 802.11g standard.

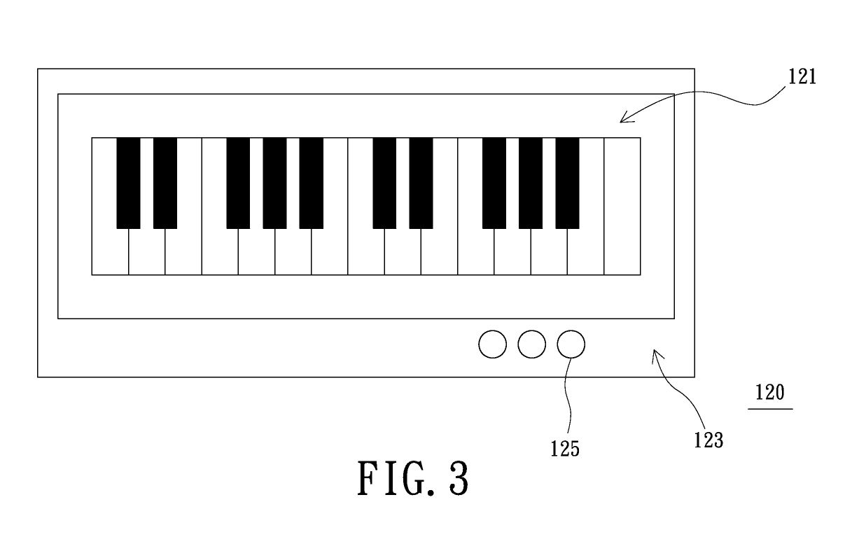

FIG. 3 is a schematic view of a display panel of the wireless operating device shown in FIG. 2. Referring to FIG. 3, the display 120 further includes a non-display area 123 surrounding the display area 121. The display area 121 is configured for displaying the operating image. The non-display area 123 includes a number of function switch keys 125. The function switch keys 125 are located at a side of the display area 121 and are electrically connected to the control module 160. The function switch keys 125 are configured for switching various operating images. The user can press the function switch keys 125 so that the control module 160 controls the display panel 120 to display various operating images.

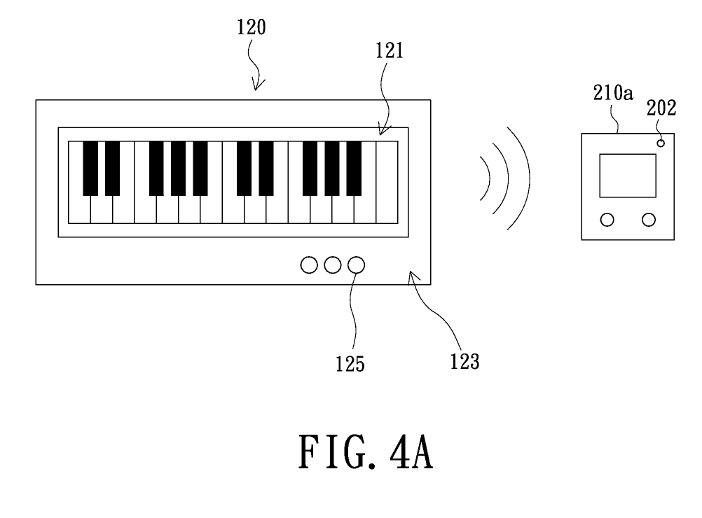

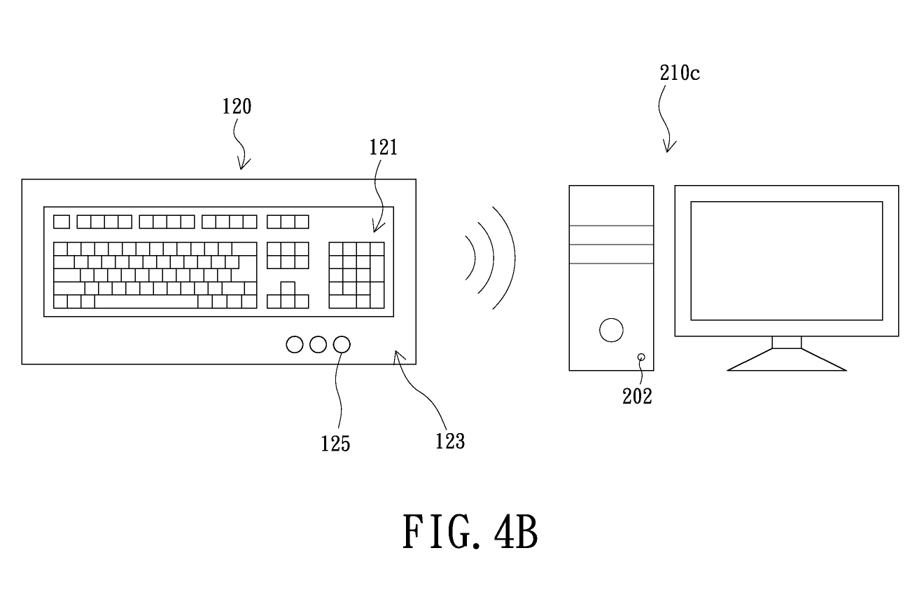

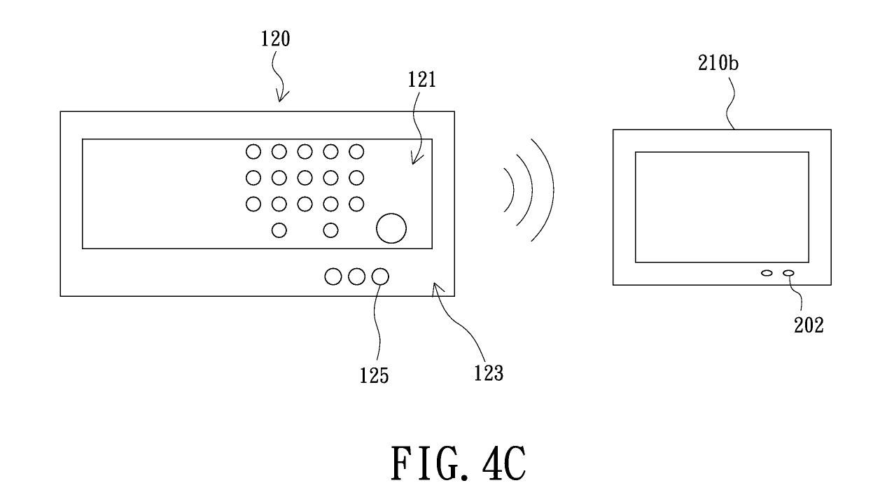

FIGS. 4A to 4C are schematic views of various operating image of the display panel of the wireless operating device, which is used for operating various electronic devices. Referring to FIG. 4A, the operating image can be a keyboard image (e.g. an organ keyboard image) for operating the electronic device 210a having a function of outputting voice. That is, the electronic device 210a can be served as an electronic organ. The electronic device 210a having the function of outputting voice can be, for example, but not limited to, a multimedia player (i.e., a music player, a video player) or a computer (i.e., a desktop computer, a handheld computer, a notebook computer).

Referring to FIG. 4B, the operating image can be a keyboard image (e.g. a computer keyboard image) for operating the electronic device 210c. The electronic device 210c is a computer such as a desktop computer, a handheld computer, a notebook computer, an all-in-one personal computer or a tablet personal computer, and so on.

Referring to FIG. 4C, the operating image can be a remote control image for operating the electronic device 210b. The remote control image includes a number of control keys. The electronic device 210b can be a multimedia player, an air conditioner, an electric fan, a stereo device, a television, a fax machine or other electronic device configured for being remotely controlled.

In the present embodiment, the user can press the function switch keys 125 to switch the operating image displayed in the display area 121 to operate any one of the electronic devices 210a, 210b and 210c. Because the wireless operating device 100 can operate the various electronic devices 210a, 210b and 210c, the wireless operating device 100 has a high compatibility and can be used conveniently and practically. Additionally, in the present embodiment, the electronic apparatus only need a wireless operating device 100 to operate each of the electronic devices 210a, 210b and 210c, thereby decreasing the number of the wireless operating device. Thus, the wireless operating device can be received and kept readily. It is noted that the operating images and the electronic devices are not limited to the operating images and the electronic devices as aforementioned.

Furthermore, in the aforementioned embodiment, the non-display area 123 includes a number of separated function switch keys 125. However, in another embodiment, the separated function switch keys 125 can be integrated into a function switch key. Thus, the user can press the integrated function switch key to switch various operating images according to the pressing number of times.

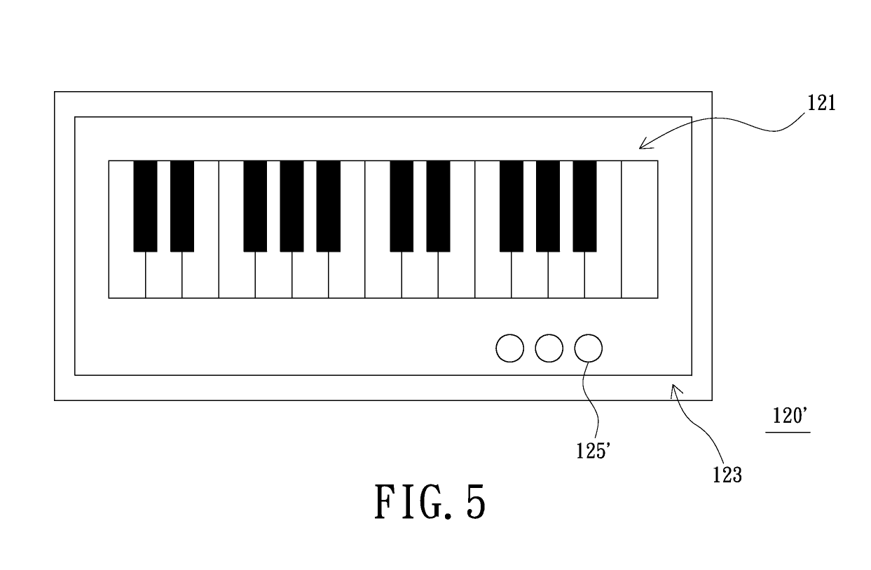

Additionally, in the aforementioned embodiment, the function switch keys 125 are entity keys disposed on the non-display area 123. However, in another embodiment shown in FIG. 5, the function switch keys 125′ can be directly displayed on the operating image as a part of the operating image. Thus, the user can touch a position on the touch panel 140 corresponding to the function switch keys 125′ to control the display panel 120′ to display the corresponding operating image.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A wireless operating device, comprising:
a display panel having a display area;
a touch panel corresponding to the displaying area of the display panel; and
a control module comprising:
a substrate electrically connected to the display panel and the touch panel;
a processing unit disposed on and electrically connected to the substrate, the processing unit being configured for controlling the display panel to display an operating image in the display area; and
a wireless transmission unit disposed on and electrically connected to the substrate, the processing unit being configured for controlling the wireless transmission unit to send an operating signal according to an operation applied on the operating image.

2. The wireless operating device as claimed in claim 1, wherein the operating image includes at least a function switch key for switching various operating images.

3. The wireless operating device as claimed in claim 1, further comprising at least a function switch key disposed at a side of the display area of the display panel and electrically connected to the control module, wherein the function switch key is configured for switching various operating images.

4. The wireless operating device as claimed in claim 1, wherein the operating image is selected from a group consisting of a keyboard image and a remote control image with a plurality of control keys.

5. The wireless operating device as claimed in claim 1, wherein the display panel is a flexible display panel.

6. The wireless operating device as claimed in claim 1, wherein the display panel is an electronic paper display panel.

7. The wireless operating device as claimed in claim 6, wherein the display panel is selected from a group consisting of an electrophoretic display panel, a cholesteric liquid crystal display panel and an electrowetting display panel.

8. The wireless operating device as claimed in claim 1, wherein the display panel is a monochrome display panel or a color display panel.

9. The wireless operating device as claimed in claim 1, wherein the touch panel is selected from a group consisting of a resistive touch panel, a capacitive touch panel, an optical touch panel, and a piezoelectric touch panel.

10. The wireless operating device as claimed in claim 1, wherein the operating signal sent from the wireless transmission unit conforms to a standard selected from a group consisting of infrared standard, bluetooth standard, radio frequency identification standard, IEEE 802.11a standard, IEEE 802.11b standard and IEEE 802.11g standard.

11. An electronic apparatus, comprising:
a wireless operating device comprising:
a display panel having a display area;
a touch panel corresponding to the displaying area of the display panel; and
a control module comprising:
a substrate electrically connected to the display panel and the touch panel;
a processing unit disposed on and electrically connected to the substrate, the processing unit being configured for controlling the display panel to display an operating image in the display area; and
a wireless transmission unit disposed on and electrically connected to the substrate, the processing unit being configured for controlling the wireless transmission unit to send an operating signal according to an operation applied on the operating image; and
at least an electronic device having a wireless receiving module for receiving the operating signal sent from the wireless operating device.

12. The electronic apparatus as claimed in claim 11, wherein the operating image includes at least a function switch key for switching various operating images.

13. The electronic apparatus as claimed in claim 11, wherein the wireless operating device further comprises at least a function switch key disposed at a side of the display area of the display panel and electrically connected to the control module, and the function switch key is configured for switching various operating images.

14. The electronic apparatus as claimed in claim 11, wherein the operating image is selected from a group consisting of a keyboard image and a remote control image with a plurality of control keys.

15. The electronic apparatus as claimed in claim 11, wherein the display panel is a flexible display panel.

16. The electronic apparatus as claimed in claim 11, wherein the display panel is an electronic paper display panel.

17. The electronic apparatus as claimed in claim 16, wherein the display panel is selected from a group consisting of an electrophoretic display panel, a cholesteric liquid crystal display panel, and an electrowetting display panel.

18. The electronic apparatus as claimed in claim 11, wherein the touch panel is selected from a group consisting of a resistive touch panel, a capacitive touch panel, an optical touch panel, and a piezoelectric touch panel.

19. The electronic apparatus as claimed in claim 11, wherein the operating signal from the wireless transmission unit conforms to a standard selected from a group consisting of infrared standard, bluetooth standard, radio frequency identification standard, IEEE 802.11a standard, IEEE 802.11b standard and IEEE 802.11g standard.

20. The electronic apparatus as claimed in claim 11, wherein the at least an electronic device is selected from a group consisting of a computer, a multimedia player, an air conditioner, an electric fan, a stereo device, a television a fax machine and combinations thereof.
